(19) United States
(12) Patent Application Publication
(10) Pub. No.: US 2025/0128379 A1
(43) Pub. Date: Apr. 24, 2025

(54) MULTI-FIELDS ASSISTED ABRASIVE SCOURING POLISHING METHOD AND DEVICE

(71) Applicants: DALIAN UNIVERSITY OF TECHNOLOGY, Dalian, Liaoning (CN); DALIAN UNIVERSITY OF TECHNOLOGY NINGBO RESEARCH INSTITUTE, Ningbo, Zhejiang (CN)

(72) Inventors: Jiang GUO, Dalian, Liaoning (CN); Renke KANG, Dalian, Liaoning (CN); Pu QIN, Dalian, Liaoning (CN); Dongming GUO, Dalian, Liaoning (CN)

(21) Appl. No.: 18/263,821

(22) PCT Filed: Aug. 18, 2022
(86) PCT No.: PCT/CN2022/113173

§ 371 Date: Jan. 6, 2025

(30) Foreign Application Priority Data
Jun. 29, 2022 (CN) 202210746928.9

(51) Int. Cl. B24B 1/00; B24B 1/04; B24B 31/00; B24B 31/12

(52) U.S. Cl. CPC B24B 1/005; B24B 1/04; B24B 31/006; B24B 31/12

(57) ABSTRACT

A multi-fields assisted abrasive scouring polishing method and device. The device includes an abrasive pool, a heating device, an ultrasonic device, a peristaltic pump and a clamping table. In use, first, magnetic poles are installed on a longitudinal rod of a workbench, and the internal channel of the workpiece is communicated with the pump inlet hose. Second, polishing slurry and abrasive particles are added into the abrasive pool, the heating end of the heating device and the vibrating end of the ultrasonic device are immersed into the polishing slurry, and the heating device and the ultrasonic device are started. Finally, a magnetic field device is energized and magnetized, and the peristaltic pump is started to polish the internal channel. The device solves the problems of poor surface quality and low polishing efficiency of a complex long and thin internal channel in a machine part containing an internal channel.

### TECHNICAL FIELD

The present invention belongs to the field of polishing methods, and relates to a multi-fields assisted polishing method for a complex internal channel.

### BACKGROUND

In the current field of machining, the machining of complex internal surfaces accounts for about one third of the amount of machining, and the machining demand of the internal channel is higher and more urgent especially in the fields such as aerospace, medical equipment and petrochemical engineering. Due to manufacturing methods and other reasons, the internal channel of a workpiece produced by rough forming has a rough surface, which is easy to cause problems of large flow resistance and much solution residue of a channel in use. Therefore, the surface quality of the internal channel shall be improved by polishing or other ways to improve the flow characteristics of internal fluid. It is difficult for the traditional polishing methods to meet the requirements when polishing an internal channel with small size, large length-diameter ratio and complex path. Therefore, it is urgent to develop an internal channel polishing process and device with high efficiency and wide range of application to solve the surface quality problem of a complex internal channel of a workpiece.

In order to solve the quality problem of the internal surface of a complex internal channel, researchers have proposed technologies such as magnetic abrasive finishing, chemical polishing and ultrasonic assisted polishing, but these internal channel polishing processes have some limitations or deficiencies in the machining range, machining efficiency and machining quality. A patent CN113211291A proposes a polishing device and method for additive manufacturing of superalloy internal channels, which, on the basis of traditional abrasive flow, can polish internal channels of superalloy parts of various sizes through the special polishing device with variable space, but are only suitable for internal channel parts with simple structure, and easily cause excessive polishing in feature positions such as turns and sharp corners for complex internal channel parts, especially for internal channel parts with large length-diameter ratio, leading to thinning of wall thickness of parts, uneven removal of different areas of internal channels and even scrap of parts, and also fail to solve the problems of complex equipment and difficulties in semi-fluid abrasive preparation of traditional abrasive flow polishing. A patent CN107460484B uses polishing slurry to chemically polish the internal channel of a polished nickel-based alloy workpiece. In this method, the prepared polishing slurry can efficiently erode convex points on the surface of the internal channel and protect concave points on the surface from excessive erosion, so as to achieve the ideal polishing effect, but the highly targeted polishing slurry is only suitable for corrosion-resistant nickel-based alloy workpieces and realizes material removal only by chemical action, thus having low polishing efficiency and being not suitable for batch machining, and chemical reagents do not conform to the conception of green manufacturing. A patent CN 109079590 B proposes a polishing method based on magnetic field assisted thickening of non-newtonian fluid, which uses an external magnetic field to improve the viscosity of non-newtonian fluid and where an external polishing slurry circulating device is arranged, which is mainly for external surface polishing, and it is difficult for high-viscosity fluid to enter a complex inner channel with large length-diameter ratio. A patent CN112339269A proposes a polishing device for a complex internal channel of a 3D printing thrust chamber, which uses vibrating high-pressure water and bubbles to flush the inner wall of the channel so as to remove dirt and impurities from the surface, but the device and method only use abrasive flow and cavitation effect to polish the internal channel, which has low efficiency and unsatisfactory polishing effect. A patent CN111299592A proposes a method for surface finishing of a component produced by additive manufacturing through ultrasonic cavitation and abrasive impact, which removes materials from the surface of a component by combination of the collapse of cavitation bubbles on the surface of the component and the impact on the surface of abrasive particles accelerated by the collapse of the cavitation bubbles. But at normal temperature, bubbles in fluid are generated only by cavitation, the material removal result of the cavitation effect is poor, the abrasive particles are not easy to cling to the wall of the internal channel for a workpiece containing an internal channel, especially a complex internal channel, polishing is performed mainly by the cavitation effect, and the effect of removing materials from the surface of the internal channel is not satisfactory.

In order to meet the surface quality requirements of the complex internal channel of the workpiece, improve the polishing efficiency of the internal channel, and keep the polishing process stable and uniform, the present invention proposes a multi-fields assisted abrasive scouring polishing process.

### SUMMARY

In view of the problems in the prior art, the present invention provides a multi-fields assisted abrasive scouring polishing process to solve the problems of poor surface quality and low polishing efficiency of a complex long and thin internal channel in a machine part containing an internal channel.

To achieve the above purpose, the present invention adopts the following technical solution:

A multi-fields assisted abrasive scouring polishing device, wherein the multi-fields assist abrasive scouring polishing process device comprises a workbench 1, an abrasive pool 4, a heating device 3, an ultrasonic device 7, a peristaltic pump 9 and a clamping table 14.

The clamping table 14 is installed at the bottom of the abrasive pool 4, and the middle part of the clamping table 14 is provided with a through hole for placing a vacuum chuck 12. The workpiece 13 is fixed above the clamping table 14 through a fixture 15, and a zigzag penetrating (from top to bottom) internal channel 11 is arranged in the workpiece 13. The bottom outlet of the internal channel 11 of the workpiece is communicated with a pump inlet hose 10 through the vacuum chuck 12.

The level of polishing slurry 5 in the abrasive pool 4 of the device is kept at a position three quarters away from the bottom of the abrasive pool 4 to submerge the workpiece 13 and the heating device 3, and shall be not overfilled to avoid overflow.

The ultrasonic device 7 of the device is installed above the abrasive pool 4, the ultrasonic tool thereof is submerged into the abrasive pool 4, the vibrating end of the tool is near and over against the top inlet of the internal channel 11 of the workpiece and forms ultrasonic waves in the polishing slurry 5 by ultrasonic vibration, the polishing slurry enters the surface of the internal channel 11 of the workpiece and cavitates, tiny bubbles or bubble nuclei oscillate, grow, shrink and collapse under the action of the ultrasonic waves, the resulting shear stress causes cracks at the bottom of surface irregularities of the internal channel to spread and finally makes the surface irregularities of the internal channel completely separate from the surface of the internal channel to form cavitation erosion to the surface of the internal channel, and at the same time, high pressure scourings produced by the collapse of cavitation bubbles push the slurry and abrasive particles to impact the surface of the workpiece to produce a micro removal effect, so as to achieve the effect of polishing the surface of the internal channel.

The heating device 3 of the device is installed at the top of one side of the abrasive pool 4, the heating end is extended into the abrasive pool 4 for heating the polishing slurry 5 in the pool to keep the polishing slurry 5 boiling so as to increase bubbles in the polishing slurry 5, and the saturated polishing slurry 5 forms a flash effect by pressure difference when entering the internal channel of the workpiece 13 to promote the cavitation effect.

The polishing slurry 5 contains magnetic abrasives 6 which can be prepared by a sintering method or atomization method and are ferromagnetic matrix micropowder embedded with hard abrasive phase. Under the action of the peristaltic pump 9, the magnetic abrasives 6 enter the internal channel of the workpiece 13 with the polishing slurry, and erode the surface of the internal channel under the hydrodynamic force of the polishing slurry 5. Meanwhile, the magnetic abrasives 6 are clung to the inner wall of the inner channel under the action of an external magnetic field device 2, the vibration wave impact of the ultrasonic device 7 directly drives the magnetic abrasives 6 in the polishing slurry to move at a high speed along the vibration direction to impact the surface of the internal channel so as to realize micro removal of materials from the surface of the internal channel 11 of the workpiece.

The workbench 1 has an L-shaped structure, the abrasive pool 4 of the device is placed on a horizontal plate of the workbench 1, a longitudinal rod of the workbench 1 is provided with a vertical slide, and a fixed ring 17 of the magnetic field device 2 is provided with magnet yokes and then installed on the longitudinal rod of the workbench 1 and can be moved up and down around the abrasive pool 4 with the longitudinal rod, so as to ensure that the magnetic abrasives 6 are clung to the inner wall of the internal channel of the workpiece and improve the material removal effect of abrasive scouring on the surface of the internal channel.

The polishing slurry 5 in the abrasive pool 4 is selectively prepared according to different manufacturing workpieces. At a certain temperature, convex peaks and concave valleys on the surface of the internal channel are selectively self-dissolved under the erosion action of chemical reagents in the polishing slurry 5 so that the metal surface becomes smooth and bright.

The pump inlet hose 10, the peristaltic pump 9 and a pump outlet hose 8 form a polishing slurry circulating device, the pump outlet hose 8 is communicated with the polishing slurry 5 from the top of the abrasive pool 4, and the pump inlet hose 10 is communicated with the internal channel 11 of the workpiece from the bottom of the abrasive pool 4. The polishing slurry and the magnetic abrasives 6 flowing out from the internal channel 11 of the workpiece return to the abrasive pool 4 through the pump inlet hose 10, the peristaltic pump 9 and the pump outlet hose 8 respectively to realize the circulation of the polishing slurry 5 in the polishing process. High-quality and high-efficiency polishing of a complex long and thin internal channel in a machine part containing an internal channel can be realized by the process.

A multi-fields assisted abrasive scouring polishing process realized on the basis of the polishing device, used for polishing the inner surface of a machine part containing an internal channel, comprising the following steps:
Step 1: installing an array of magnetic poles 16 on the fixed ring 17 to form the magnetic field device 2, installing the fixed ring 17 on the longitudinal rod of the workbench 1, and moving up and down to select an appropriate working height.
Step 2: selecting an appropriate fixture 15 to fix the workpiece 13 on the clamping table 14, and communicating the internal channel 11 of the workpiece 13 with the pump inlet hose 10 through the vacuum chuck 12.
Step 3: adding the polishing slurry 5 and the abrasive particles 6 into the abrasive pool 4 until the level in the abrasive pool 4 submerges the workpiece 13 and rises to about three quarters of the abrasive pool 4, and immersing the heating end of the heating device 3 and the vibrating end of the ultrasonic device 7 into the polishing slurry 5.
Step 4: starting the heating device 3 to make the temperature of the polishing slurry 5 in the abrasive pool 4 rise continuously and reach the boiling state.
Step 5: adjusting the position of the ultrasonic device 7 so that the vibrating end of the ultrasonic tool is near and over against the inlet of the internal channel 11 of the workpiece.
Step 6: starting the ultrasonic device 7 to realize ultrasonic vibration at the end, and ultrasonic waves form an ultrasonic field in the polishing slurry 5 to make the polishing slurry 5 reach the cavitation conditions.
Step 7: energizing and magnetizing the magnetic field device 2, starting the peristaltic pump 9 to suck the polishing slurry 5 and the magnetic abrasive particles into the internal channel 11, and achieving the conditions of flash evaporation at the inlet of the internal channel 11 of the workpiece. Setting operating parameters, adjusting the flow velocity of the polishing slurry 5 in the internal channel 11 of the workpiece, and circulating the polishing slurry 5 to polish the internal channel 11 of the workpiece.
Step 8: demagnetizing the magnetic field device 2, turning off the peristaltic pump 9, the heating device 3 and the ultrasonic device 7 in sequence, removing the workpiece 13 from the fixture 15, and cleaning the workpiece.

The present invention has the following beneficial effects:
(1) The present invention proposes a multi-fields assisted abrasive scouring polishing process, which polishes the inner surface of a workpiece simultaneously by three material removal methods of chemical surface modification, ultrasonic cavitation and abrasive scouring to realize 360° full polishing of the internal channel of the workpiece, makes up for the disadvantage of removing materials by a single polishing mechanism and improves the polishing quality and polishing efficiency of the internal channel.
(2) Through the arrangement of the heating device in the present invention, the polishing slurry produces a flash effect when entering the internal channel of the workpiece and forming pressure difference so that the polishing slurry generates drastic phase transformation and produces a large number of bubbles, which enhances the cavitation of the slurry in the abrasive pool and increases the level of cavitation erosion of cavitation bubbles to the internal channel of the workpiece.
(3) Through the arrangement of the ultrasonic device, the present invention provides cavitation conditions for the polishing slurry and stirs and mixes the polishing slurry and abrasives, which ensures the homogenization of chemical reagents in the polishing slurry and the uniform distribution of abrasive particles, so as to achieve uniform polishing of the polishing slurry and abrasive particles to the internal channel of the workpiece.
(4) Through the arrangement of the fixture in the present invention, the fixture can be replaced according to different workpieces, which ensures that internal channels of different workpieces can be polished by the process device and ensures the flexibility, adjustability and practicability of the process.
(5) The present invention can save the cost and bring huge environmental benefits by realizing the circulation of the polishing slurry in the polishing process.
(6) The present invention mainly uses ultrasound to drive abrasive particle vibration, ultrasonic cavitation and chemical polishing slurry erosion to remove materials from the surface of the internal channel mainly without the need of high flow velocity, which avoids excessive polishing of feature positions such as turns and sharp corners of the internal channel of an internal channel part with large length-diameter ratio due to scouringting of the polishing slurry and ensures that the removal amount in different areas of the internal channel is uniform.
(7) By means of adding the abrasive particles in the polishing slurry, the present invention differs from traditional abrasive flow machining in which muddy abrasive particles with considerable viscosity are directly added into the internal channel of a part to be machined, which avoids adhesion residues of abrasive particles on the surface of the internal channel of the workpiece, especially feature positions such as turns and sharp corners, during traditional abrasive flow machining of the internal channel and ensures the cleaning of the machined internal channel of the workpiece to a certain extent.
(8) In the present invention, the magnetic abrasives are used, the magnet yokes area arranged, the magnetic abrasives are clung to the inner wall of the internal channel under the action of the magnetic field for scouringting to remove materials, and the vibration radiation surface of the ultrasonic device directly drives the abrasive particles in the slurry to move at a high speed along the vibration direction to impact the surface of the workpiece so as to result in microplastic deformation and microdamage removal of the surface of the workpiece, which greatly improves the physical removal efficiency of abrasive scouring on the surface of the internal channel.
(9) In the process of the present invention, various mechanisms of action are complementary, the slurry cavitates under the action of ultrasonic vibration, and high pressure scourings produced by the collapse of cavitation bubbles push the slurry and abrasive particles to impact the surface of the workpiece, which increases the extent of contact between the polishing slurry and abrasive particles and the surface of the internal channel and improves the removal efficiency of chemical polishing and abrasive scouring for the surface of the internal channel by the cavitation effect to a certain extent.

### DESCRIPTION OF DRAWINGS

FIG. 1 is a flow chart of a multi-fields assisted abrasive scouring polishing process for an internal channel of a workpiece of the present application.

FIG. 2 is a structural schematic diagram of a process of the present application;

FIG. 3 is a top view of a process device of the present application;

FIG. 4 is a schematic diagram of cavitation erosion of the surface of an internal channel in a process of the present application;

In the figures: 1 workbench; 2 magnetic field device 3 heating device; 4 abrasive pool; 5 polishing slurry; 6 magnetic abrasive particles; 7 ultrasonic device; 8 pump outlet hose; 9 peristaltic pump; 10 pump inlet hose; 11 internal channel of workpiece; 12 vacuum chuck; 13 workpiece; 14 clamping table; 15 fixture; 16 magnetic pole; and 17 fixed ring.

### DETAILED DESCRIPTION

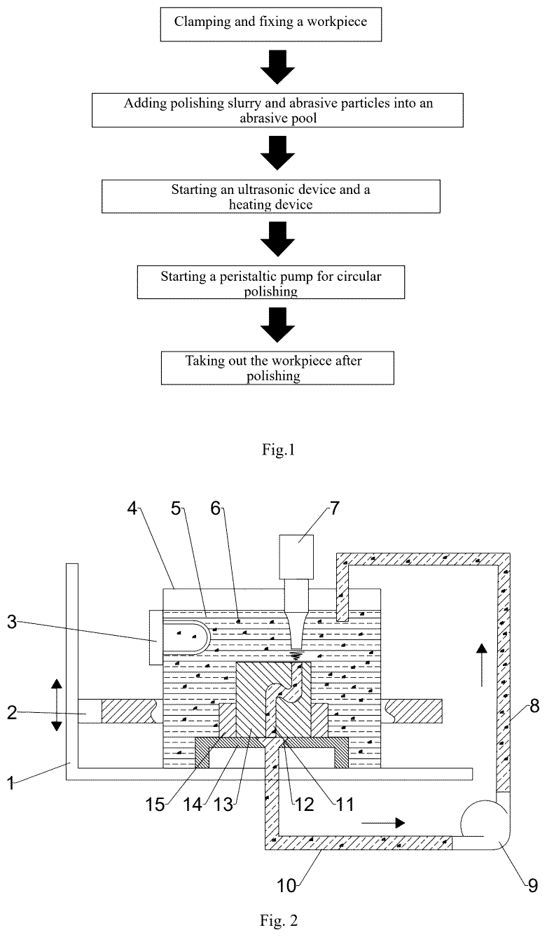

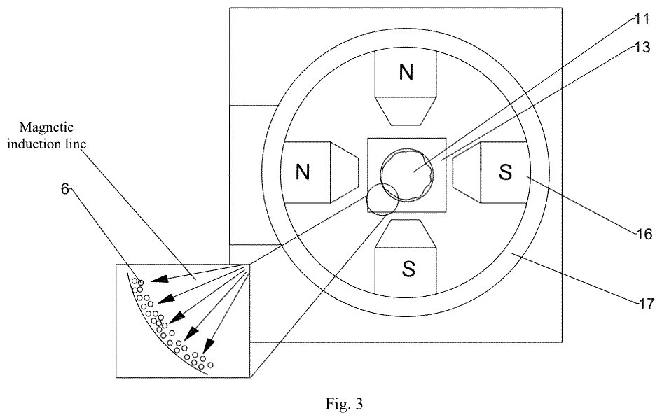

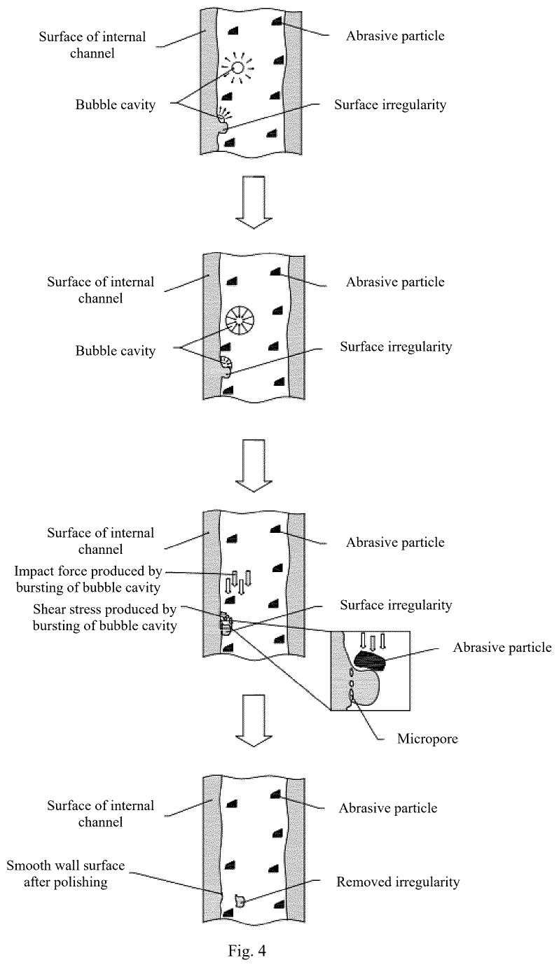

The method for polishing the internal surface of the present invention is described in detail in combination with FIG. 2 and FIG. 3.

FIG. 2 is a structural schematic diagram of an ultrasonic assisted chemical abrasive scouring polishing process for polishing an internal channel of a workpiece of the present invention.

A multi-fields assisted abrasive scouring polishing process is used for polishing each internal channel in a machine part containing internal channels. The multi-fields assisted abrasive scouring polishing process device comprises a workbench 1, an abrasive pool 4, a heating device 3, an ultrasonic device 7, a peristaltic pump 9 and a clamping table 14.

The clamping table 14 of the device is installed at the bottom of the abrasive pool 4, the workpiece 13 is fixed above the clamping table 14 through a fixture 15, and the outlet of the internal channel 11 of the workpiece 13 is communicated with a pump inlet hose 10 through a vacuum chuck 12. The level of polishing slurry 5 in the abrasive pool 4 of the device is kept at a position three quarters away from the bottom of the abrasive pool 4 and shall be not overfilled to avoid overflow.

The heating device 3 of the device is installed above the abrasive pool 4, the heating end is extended into the abrasive pool 4 for heating the polishing slurry 5 in the pool to keep the polishing slurry 5 boiling so as to increase bubbles in the polishing slurry 5, and the polishing slurry 5 forms a flash effect by pressure difference when entering the internal channel 11.

The ultrasonic device 7 of the device is installed above the abrasive pool 4, the ultrasonic tool thereof is submerged into the abrasive pool 4 and is near and over against the inlet of the internal channel 11 of the workpiece, ultrasonic waves produced by the ultrasonic device 7 form an ultrasonic field in the polishing slurry 5 so that the polishing slurry cavitates when entering the internal channel 11 of the workpiece 13, tiny bubbles or bubble nuclei oscillate, grow, shrink and collapse under the action of the ultrasonic waves, the resulting shear stress causes cracks at the bottom of surface irregularities of the internal channel to spread and finally makes the surface irregularities of the internal channel completely separate from the surface of the internal channel to form cavitation erosion to the surface of the internal channel, and at the same time, high pressure scourings produced by the collapse of cavitation bubbles push the slurry and abrasive particles to impact the surface of the workpiece to produce a micro removal effect, so as to achieve the effect of polishing the surface of the internal channel.

Under the action of the peristaltic pump 9, magnetic abrasives 6 of the device enter the internal channel 11 of the workpiece with the polishing slurry 5, and erode the surface of the internal channel 11 under the hydrodynamic force of the polishing slurry 5. Meanwhile, the magnetic abrasives 6 are clung to the inner wall of the inner channel 11 under the action of the magnetic field device 2 so that the vibration radiation surface of the ultrasonic device directly drives the magnetic abrasives 6 in the polishing slurry 5 to move at a high speed along the vibration direction to impact the surface of the internal channel 11 so as to realize micro removal of materials from the surface of the internal channel 11.

The abrasive pool 4 of the device is placed on the workbench 1, and a fixed ring 17 is provided with magnetic poles 16 and then installed on a longitudinal rod of the workbench 1 and can be moved up and down around the abrasive pool 4 with the longitudinal rod, so as to ensure that the magnetic abrasives 3 are clung to the inner wall of the internal channel 11 of the workpiece and improve the material removal effect of abrasive scouring on the surface of the internal channel 11.

The polishing slurry 5 in the abrasive pool 4 of the device is selectively prepared according to different manufacturing workpieces. At a certain temperature, convex peaks and concave valleys on the surface of the internal channel are selectively self-dissolved under the erosion action of chemical reagents in the polishing slurry 5 so that the metal surface becomes smooth and bright.

The vacuum chuck 12 of the device is used for connecting the pump inlet hose 10 and the workpiece 13 and ensuring that the internal channel 11 of the workpiece 13 is communicated with the pump inlet hose 10.

The pump inlet hose 10, the peristaltic pump 9 and a pump outlet hose 8 of the device form a polishing slurry circulating device, the polishing slurry 5 and the magnetic abrasives 6 flowing out from the internal channel 11 of the workpiece return to the abrasive pool 4 through the pump inlet hose 10, the peristaltic pump 9 and the pump outlet hose 8 respectively to realize the circulation of the polishing slurry in the polishing process. High-quality and high-efficiency polishing of a complex long and thin internal channel in a machine part containing an internal channel can be realized by the process.

Because the internal channel is located in the workpiece with small volume and zigzag shape, it is difficult to polish an internal channel with small size, large length-diameter ratio and complex path by traditional polishing methods. The present invention proposes a multi-fields assisted abrasive scouring polishing process, which has high polishing efficiency and high polishing quality for an internal channel and comprises the specific implementation steps as follows:
Step 1: installing an array of magnet yokes on the fixed ring, installing the fixed ring on the longitudinal rod of the workbench, and moving up and down to select an appropriate working height.
Step 2: selecting an appropriate fixture 15 to fix the workpiece 13 on the clamping table 14, the internal channel 11 of the workpiece has three sections and two bends, with an inner diameter of 5 mm and a length of 120 mm, and the outlet is communicated with the pump inlet hose 10 through the vacuum chuck 12.
Step 3: adding the polishing slurry and the abrasive particles into the abrasive pool 4 until the level in the abrasive pool 4 submerges the workpiece 13 and rises to about three quarters of the abrasive pool 4, and immersing the heating end of the heating device 3 and the ultrasonic tool of the ultrasonic device 7 into the polishing slurry 5.
Step 4: starting the heating device 3 to make the temperature of the polishing slurry 5 in the abrasive pool 4 rise continuously to 100° C. and reach the boiling state at normal atmospheric pressure.
Step 5: adjusting the position of the ultrasonic device 7 so that the vibrating end of the ultrasonic tool is near and over against the inlet of the internal channel 11 of the workpiece.
Step 6: starting the ultrasonic device 7, and setting the ultrasonic frequency to 20 kHz, the ultrasonic tool vibrates to produce ultrasonic waves, and the ultrasonic waves form an ultrasonic field in the polishing slurry 5 to make the polishing slurry reach the cavitation conditions.
Step 7: energizing and magnetizing the magnetic field device 2, and setting the magnetic field intensity to 5000 gauss. Starting the peristaltic pump 9, setting the flow velocity to 300 mL/min, and circulating the polishing slurry 5 through the peristaltic pump 9 to polish the internal channel of the workpiece 13.
Step 8: demagnetizing the magnetic field device 2, turning off the peristaltic pump 9, the heating device 3 and the ultrasonic device 7 in sequence, removing the workpiece 13 from the fixture 15, and cleaning the workpiece.

The above is just preferred embodiments of the present invention and is not intended to limit the present invention. Any modification, equivalent replacement, improvement, etc. made within the spirit and the principle of the present invention shall be contained within the protection scope of the present invention.

1. A multi-fields assisted abrasive scouring polishing device, wherein the multi-fields assisted abrasive scouring polishing process device comprises a workbench, a magnetic field device, an abrasive pool, a heating device, an ultrasonic device, a peristaltic pump and a clamping table;
the clamping table is installed at the bottom of the abrasive pool, and the middle part of the clamping table is provided with a through hole for placing a vacuum chuck; a workpiece is fixed above the clamping table through a fixture, a zigzag penetrating internal channel is arranged in the workpiece, and the bottom outlet of the internal channel is communicated with a pump inlet hose through the vacuum chuck;
the ultrasonic device is installed above the abrasive pool, the vibrating end of the tool is over against the top inlet of the internal channel of the workpiece and forms ultrasonic waves in the polishing slurry by ultrasonic vibration, and the polishing slurry enters the surface of the internal channel of the workpiece and cavitates to achieve the effect of polishing the surface of the internal channel;
the heating device is installed at the top of one side of the abrasive pool for heating the polishing slurry in the pool to keep the polishing slurry boiling, and the saturated polishing slurry forms a flash effect by the pressure difference when entering the internal channel to promote the cavitation effect;
the polishing slurry contains magnetic abrasives which are ferromagnetic matrix micro-powder embedded with hard abrasive phase; and under the action of the peristaltic pump, the magnetic abrasives enter the internal channel with the polishing slurry to realize micro removal of materials from the surface of the internal channel of the workpiece;
the workbench has an L-shaped structure, the abrasive pool is placed on a horizontal plate of the workbench, a longitudinal rod of the workbench is provided with a vertical slide, and a fixed ring of the magnetic field device is provided with magnet yokes and then installed on the vertical slide and can be moved up and down, so as to ensure that the magnetic abrasives are clung to the inner wall of the internal channel of the workpiece and improve the material removal effect of abrasive scouring on the surface of the internal channel;
the peristaltic pump, the pump inlet hose and a pump outlet hose form a polishing slurry circulating device to realize the circulation of the polishing slurry in the polishing process.

2. A multi-fields assisted abrasive scouring polishing process realized on the basis of the polishing device of claim 1, wherein the process is used for polishing the inner surface of a machine part containing an internal channel, comprising the following steps:
step 1: installing an array of magnetic poles on the fixed ring to form the magnetic field device, installing the fixed ring on the longitudinal rod of the workbench, and moving up and down to select an appropriate working height;
step 2: selecting an appropriate fixture to fix the workpiece on the clamping table, and communicating the internal channel of the workpiece with the pump inlet hose through the vacuum chuck;
step 3: adding the polishing slurry and the abrasive particles into the abrasive pool until the level in the abrasive pool submerges the workpiece and rises to about three quarters of the abrasive pool, and immersing the heating end of the heating device and the vibrating end of the ultrasonic device into the polishing slurry;
step 4: starting the heating device to make the temperature of the polishing slurry in the abrasive pool rise continuously and reach the boiling state;
step 5: adjusting the position of the ultrasonic device so that the vibrating end of the ultrasonic tool is near and over against the inlet of the internal channel of the workpiece;
step 6: starting the ultrasonic device to realize ultrasonic vibration at the end, and forming an ultrasonic field in the polishing slurry by ultrasonic waves to make the polishing slurry reach the cavitation conditions;
step 7: energizing and magnetizing the magnetic field device, starting the peristaltic pump to suck the polishing slurry and the magnetic abrasive particles into the internal channel, and achieving the conditions of flash evaporation at the inlet of the internal channel of the workpiece; and setting operating parameters, adjusting the flow velocity of the polishing slurry in the internal channel of the workpiece, and circulating the polishing slurry to polish the internal channel of the workpiece;
step 8: demagnetizing the magnetic field device, turning off the peristaltic pump, the heating device and the ultrasonic device in sequence, and taking out the workpiece after the polishing slurry is cooled.
